(19) United States
(12) Patent Application Publication
(10) Pub. No.: US 2025/0317316 A1
(43) Pub. Date: Oct. 9, 2025

(54) MEETING MINUTES AUTOMATIC GENERATION SYSTEM AND MEETING MINUTES AUTOMATIC GENERATION METHOD

(71) Applicant: INVENTEC APPLIANCES CORPORATION, New Taipei City (TW)

(72) Inventors: CHUN-PIN LAN, New Taipei City (TW); Shyh-Shian Liao, New Taipei City (TW); CHE-HUNG YEH, New Taipei City (TW); TENG-CHUNG HSU, New Taipei City (TW)

(21) Appl. No.: 18/792,483

(22) Filed: Aug. 1, 2024

(30) Foreign Application Priority Data
Apr. 8, 2024 (TW) 113112869

(51) Int. Cl. H04L 12/18; G06V 40/16; G10L 17/02; G10L 17/10

(52) U.S. Cl. CPC H04L 12/1831; G06V 40/166; G06V 40/172; G10L 17/02; G10L 17/10

(57) ABSTRACT

A meeting minutes automatic generation system and a meeting minutes automatic generation method are provided. The meeting minutes automatic generation system includes a control circuit, a voice capturing device and storage device. The voice capturing device captures voice records of members. The control circuit accesses the storage device to execute a comparison program, a speech-to-text conversion program, and a meeting minutes generation program. The comparison program identifies members' identities corresponding to the voice records. The speech-to-text conversion program converts the voice records into text records. The meeting minutes generation program determines importance levels of the text records based on the members' identities The meeting minutes generation program generates an overall meeting minutes based on the text records and the importance levels in a mute mode and a non-mute mode, and the control circuit sends the overall meeting minutes to the members according to the importance levels.

### CROSS-REFERENCE TO RELATED PATENT APPLICATION

This application claims the benefit of priority to Taiwan Patent Application No. 113112869, filed on Apr. 8, 2024. The entire content of the above identified application is incorporated herein by reference.

### FIELD OF THE DISCLOSURE

The present disclosure relates to a meeting minutes system and a meeting minutes method, particularly to a meeting minutes automatic generation system and a meeting minutes automatic generation method.

### BACKGROUND OF THE DISCLOSURE

Thanks to technological advances, an artificial intelligence interface can be activated during video conferences, and the artificial intelligence interface can organize meeting minutes based on the speaker's voice.

However, since the artificial intelligence interface cannot determine the identity of each speaker or the importance of the spoken content, the accuracy of the generated meeting minutes are often not high and still requires modification. Furthermore, when the video conference device is switched to a mute mode, the artificial intelligence interface cannot organize the meeting minutes. The artificial intelligence interface also cannot determine the confidentiality level of the meeting minutes, so that the meeting minutes cannot be sent to the corresponding speakers based on the confidentiality level.

### SUMMARY OF THE DISCLOSURE

The technical problem to be solved by the present disclosure is to provide a meeting minutes automatic generation system and a meeting minutes automatic generation system method that address the deficiencies of the existing technology.

To solve the aforementioned technical problems, one technical solution adopted by the present disclosure is to provide a meeting minutes automatic generation system. The meeting minutes automatic generation system includes a control circuit, a voice capturing device, and a storage device. The voice capturing device is electrically connected to the control circuit and captures a plurality of voice records. The storage device is electrically connected to the control circuit. The control circuit accesses the storage device to execute a comparison program, a speech-to-text conversion program, and a meeting minutes generation program. The comparison program identifies an identity of each of a plurality of members corresponding to each of the plurality of voice records. The speech-to-text conversion program converts the plurality of voice records into a plurality of text records. The meeting minutes generation program determines an importance level of each of the plurality of text records based on the identity of each of the plurality of members and generates an overall meeting minutes based on the plurality of text records and importance levels of the plurality of text records.

To solve the aforementioned technical problems, another technical solution adopted by the present disclosure is to provide a meeting minutes automatic generation method. The meeting minutes automatic generation method includes: capturing a plurality of voice records of a plurality of members through a voice capturing device; accessing a storage device through the control circuit to execute a comparison program, in which the comparison program identifies an identity of each of the plurality of members corresponding to each of the plurality of voice records; accessing the storage device through the control circuit to execute a speech-to-text conversion program, in which the speech-to-text conversion program converts the plurality of voice records into a plurality of text records; and accessing the storage device through the control circuit to execute a meeting minutes generation program, in which the meeting minutes generation program generates an overall meeting minutes based on the plurality of text records and importance levels of the plurality of text records.

One beneficial effect of the present disclosure is that the meeting minutes automatic generation system and the meeting minutes automatic generation method provided by the present disclosure, as the overall meeting minutes are generated based on the identity of each member and the importance level of the spoken content, serve as the basis for organizing meeting minutes, thereby enhancing the accuracy of the meeting minutes.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic diagram of the meeting minutes automatic generation system according to the first embodiment of the present disclosure.

FIG. 2 is a schematic diagram of the meeting minutes automatic generation system in a sound mode.

FIG. 3 is a schematic diagram of the meeting minutes automatic generation system according to the second embodiment of the present disclosure.

FIG. 4 is a schematic diagram of the meeting minutes automatic generation system according to the third embodiment of the present disclosure.

FIG. 5A and FIG. 5B are flowcharts of the meeting minutes automatic generation method according to the first embodiment of the present disclosure.

FIG. 6 is a flowchart of the meeting minutes automatic generation method according to the second embodiment of the present disclosure.

FIG. 7A and FIG. 7B are flowcharts of the meeting minutes automatic generation method according to the third embodiment of the present disclosure.

### DETAILED DESCRIPTION OF THE EXEMPLARY EMBODIMENTS

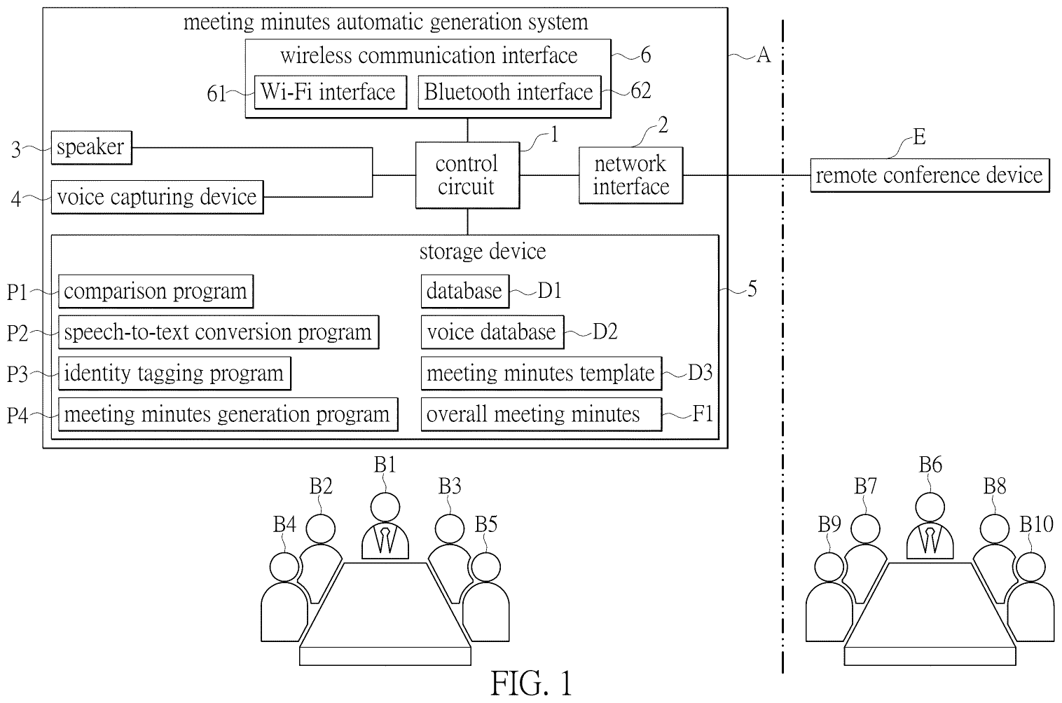

FIG. 1 is a schematic diagram of a meeting minutes automatic generation system according to the first embodiment of the present disclosure. Referring to FIG. 1, a meeting minutes automatic generation system A includes a control circuit 1, a network interface 2, a speaker 3, a voice capturing device 4, a storage device 5, and a wireless communication interface 6. The control circuit 1, for example, can be an embedded controller, an application-specific integrated circuit, a field-programmable gate array, a microcontroller unit, or a system on a chip, or any combination thereof. The speaker 3, for example, can be an immersive speaker or a Bluetooth speaker. The voice capturing device 4, for example, can be a capacitive microphone or a directional microphone. The storage device 5, for example, can be a programmable read-only memory, an erasable programmable read-only memory, or a flash memory.

The control circuit 1 is electrically connected to the network interface 2 and the speaker 3, and the meeting minutes automatic generation system A in a local conference room can establish a network connection with a remote conference device E through the network interface 2. The remote conference device E, for instance, can be a teleconference machine or a video conference machine. Specifically, there are five members B1, B2, B3, B4, and B5 in the local conference room, while there are five members B6, B7, B8, B9, and B10 in the remote conference room. When the members in the remote conference room speak, the speaker 3 plays the sound of the members in the remote conference room. The voice capturing device 4 is electrically connected to the control circuit 1, and the voice capturing device 4 captures the voice record of each member.

The storage device 5 is electrically connected to the control circuit 1, and the storage device 5 stores a comparison program P1, a speech-to-text conversion program P2, an identity tagging program P3, a meeting minutes generation program P4, a database D1, a voice database D2, and a meeting minutes template D3. The control circuit 1 accesses the storage device 5 to execute the comparison program P1. Specifically, the comparison program P1 can be a voiceprint comparison program, and the database D1 is a voiceprint database that includes identities of a plurality of members and reference voiceprint features corresponding to the identities of the plurality of members. The voiceprint comparison program compares each voice record with the reference voiceprint features in the voiceprint database to identify the identities of the plurality of members corresponding to the voice records, which may include name and rank of the member, but the present disclosure is not limited thereto.

When member B1 speaks, the voiceprint comparison program compares the voice record of member B1 with the reference voiceprint features in the voiceprint database to identify the name and rank of member B1. The database D1 is not limited to a voiceprint database, and as long as it contains the speech feature and the identity of the member, the comparison program P1 can identify the speaker.

The control circuit 1 accesses the storage device 5 to execute the speech-to-text conversion program P2. The speech-to-text conversion program P2 converts the plurality of voice records into a plurality of text records. Specifically, the voice database D2 contains a plurality of reference voices and a plurality of reference texts corresponding to the plurality of reference voices. Each voice record captured by the voice capturing device 4 may contain a plurality of sub-voice records, such as meeting topics, meeting times, attendance numbers, member names, member ranks, or technical terms. The control circuit 1 compares each sub-voice record with the reference voices in the voice database D2. When the control circuit 1 determines that a sub-voice record matches a reference voice, it can identify the reference text corresponding to the sub-voice record.

The control circuit 1 accesses the storage device 5 to execute the identity tagging program P3, and the identity tagging program P3 tags the identities of the plurality of members on the plurality of text records.

The control circuit 1 accesses the storage device 5 to execute the meeting minutes generation program P4, and the meeting minutes generation program P4 determines an importance level of the text record of each of the plurality of member based on the identity of each of the plurality of member and generates the overall meeting minutes F1 based on the plurality of text records and the importance levels of the plurality of text records. The overall meeting minutes F1 is a meeting text record between the meeting minutes automatic generation system A in the local conference room and at least one remote conference device E.

For example, members may include a general manager, managers, deputy managers, and directors. The higher the rank of a member is, the higher the importance level of the text records is. Thus, when editing the overall meeting minutes F1, the meeting minutes generation program P4 prioritizes the text records of the general manager and other members whose views are similar to those of the general manager as the focus of the meeting, and the text records of managers and others with similar views to the managers are treated as secondary focus points, and so forth.

Regarding the editing of the overall meeting minutes F1, for example, the meeting minutes template D3 includes several blank fields, such as fields for the meeting topic, meeting time, member, and spoken content. The meeting minutes generation program P4 can fill in the meeting topic, meeting time, member names, and spoken content as they appear in the text records into the corresponding fields of the meeting minutes template D3 to generate the overall meeting minutes data F1.

After the editing of the overall meeting minutes data F1 is completed, the meeting minutes automatic generation system A can transmit the overall meeting minutes F1 to the remote conference device E via the network interface 2, allowing the members in the remote conference room to refer to and review the overall meeting minutes F1.

The wireless communication interface 6 is electrically connected to the control circuit 1, and may include a Wi-Fi interface 61 and a Bluetooth interface 62. Besides the conference mode described earlier, the meeting minutes automatic generation system A can also enter a sound mode through the wireless communication interface 6.

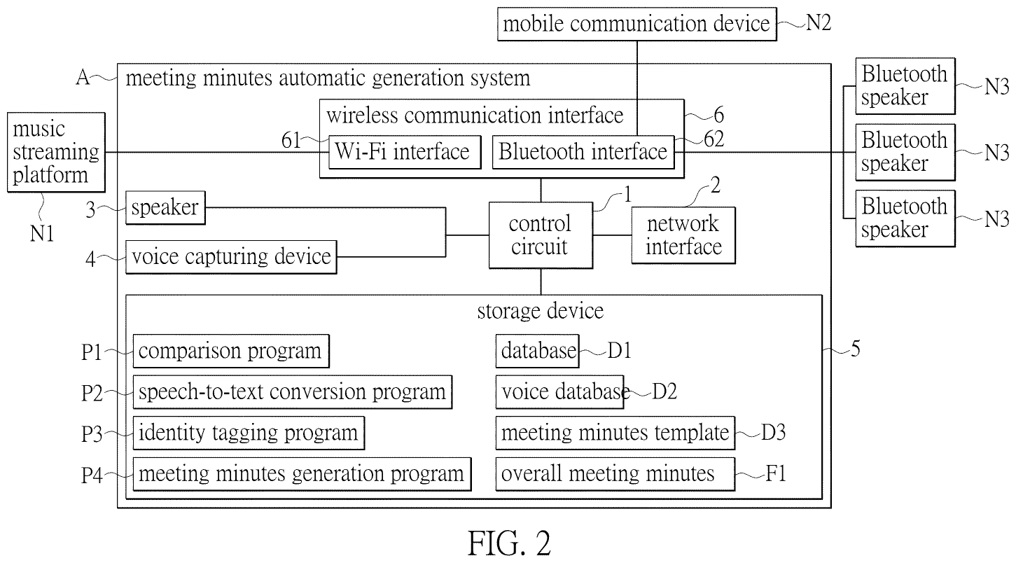

FIG. 2 shows the meeting minutes automatic generation system A in a sound mode. The meeting minutes automatic generation system A connects to a music streaming platform N1 through the Wi-Fi interface 61, such as YouTube or KKBOX, and plays music from the music streaming platform N1 through the speaker 3. The meeting minutes automatic generation system A also connects to a mobile communication device N2 via the Bluetooth interface 62, such as a smartphone or tablet, and plays music stored in the mobile communication device N2 through the speaker 3. Additionally, the meeting minutes automatic generation system A connects to the plurality of Bluetooth speakers N3 through the Bluetooth interface 62, and the speaker 3 plays music along with the Bluetooth speakers N3 simultaneously, thereby creating a theater-like or immersive auditory experience.

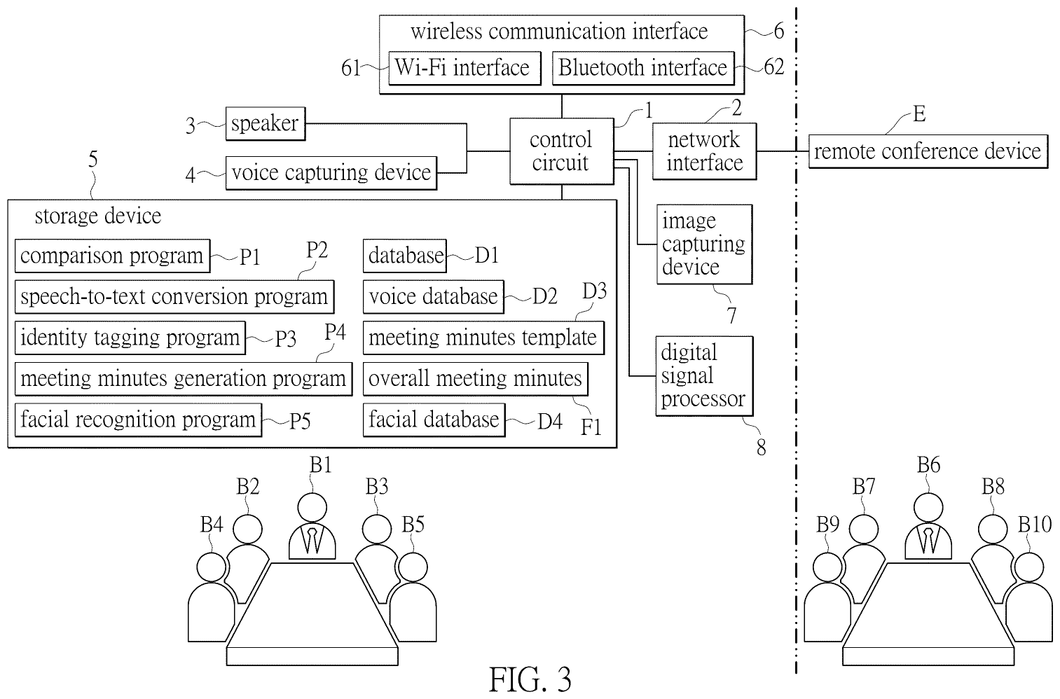

FIG. 3 is a schematic diagram of the meeting minutes automatic generation system A according to the second embodiment of the present disclosure. Compared to FIG. 1, the differences of the present embodiment are as follows.

The meeting minutes automatic generation system A further includes an image capturing device 7 and a digital signal processor 8, and the image capturing device 7 and the digital signal processor 8 are electrically connected to the control circuit 1. The image capturing device 7 captures meeting images, including background and member images. The storage device 5 further stores a facial recognition program P5 and a facial database D4, and the facial database D4 contains identities of a plurality of members and a plurality of reference facial features corresponding to the identities of the plurality of members.

The control circuit 1 accesses the storage device 5 to execute the facial recognition program P5, and the facial recognition program P5 captures facial images from the meeting images and compares the facial images with the reference facial features in the facial database D4, thereby identifying the identifies of the plurality of members corresponding to the facial images.

Furthermore, the control circuit 1 can also identify the relative angles between the center points of each facial image and the center point of the meeting minutes automatic generation system A based on two-dimensional coordinate information. The digital signal processor 8 not only performs echo cancellation and noise suppression on voice records but also conducts voice direction detection, thereby identifying the relative angles between the sound sources and the center point of the meeting minutes automatic generation system A. The digital signal processor 8 can also perform audio quality enhancement processing, enabling the speaker 3 to play immersive quality sound. The control circuit 1 compares the relative angles of each facial image with the relative angles of the sound sources. When the relative angles of a facial image match those of a sound source, theidentifies of the plurality of member are confirmed. Since the identification of member identities involves both voiceprint and facial recognition, the accuracy of identification can be enhanced.

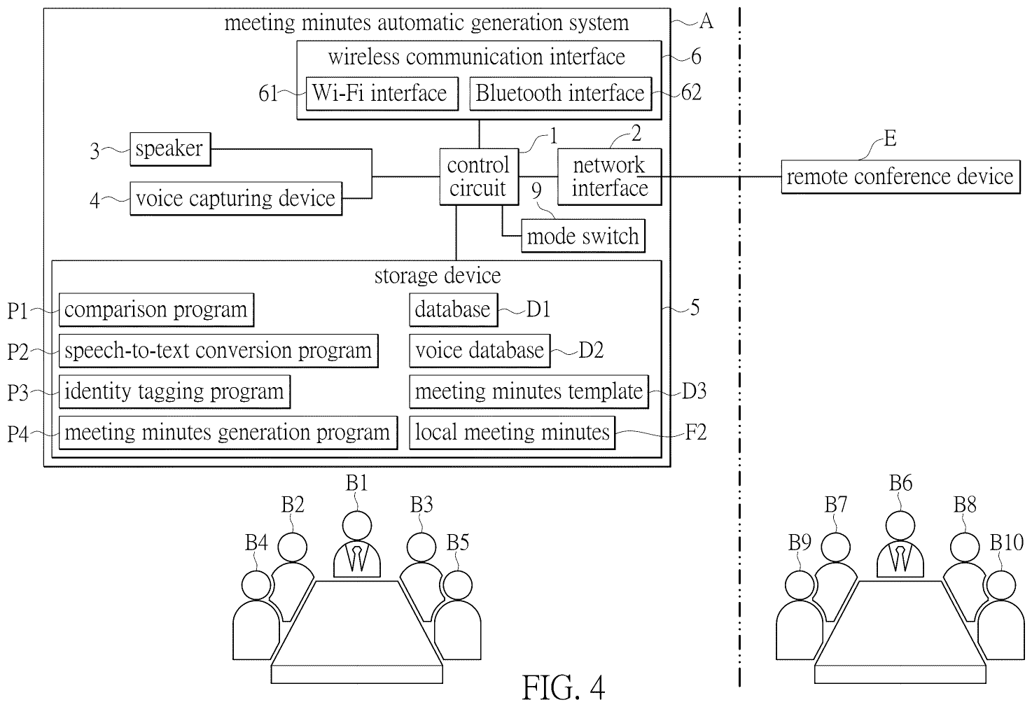

FIG. 4 is a schematic diagram of the meeting minutes automatic generation system A according to the third embodiment of the present disclosure. Compared to FIG. 1, the differences of the present embodiment are as follow.

The meeting minutes automatic generation system A further includes a mode switch 9, and the mode switch 9 may be a button switch or a dial switch, and is electrically connected to the control circuit 1. By operating the mode switch 9, users can switch the meeting minutes automatic generation system A from a mute mode to a non-mute mode, or vice versa.

The mode switch 9 is just an example, and the present disclosure is not limited thereto. The meeting minutes automatic generation system A can also capture user gestures and determine whether the user gestures match pre-set reference gestures. When a user gesture matches a reference gesture, the meeting minutes automatic generation system A switches from a non-mute mode to a mute mode, or vice versa. Additionally, the mode switching can also be performed via voice commands.

In the non-mute mode, the control circuit 1 allows a voice record of a member in the local conference room to be transmitted to the remote conference device E, and allows the speaker 3 to play the voice record of the member in the remote conference room. In the mute mode, the control circuit 1 prohibits the transmission of the voice record of the member in the local conference room to the remote conference device E, and prohibits the speaker 3 from playing the voice record of the member in remote conference room.

In the mute mode, the member in the local conference room can conduct an internal meeting, and the meeting minutes automatic generation system A can also generate a meeting minutes of the internal meeting.

First, the voice capturing device 4 captures a plurality of local voice records of a plurality of members in the local conference room in the mute mode.

Subsequently, the control circuit 1 accesses the storage device 5 to execute the voiceprint comparison program, and the voiceprint comparison program compares each local voice record with the reference voiceprint features in the voiceprint database, thereby identifying the names and ranks of the plurality of members in the local conference room corresponding to the plurality of local voice records.

Next, the control circuit 1 accesses the storage device 5 to execute the speech-to-text conversion program P2, and the speech-to-text conversion program P2 converts the plurality of local voice records into a plurality of local text records.

Then, the control circuit 1 accesses the storage device 5 to execute the identity tagging program P3, and the identity tagging program P3 tags identities of the plurality of members on the plurality of local text records.

Finally, the control circuit 1 accesses the storage device 5 to execute the meeting minutes generation program P4, and the meeting minutes generation program P4 determines an importance level of each of the plurality of local text records of each of the plurality of members based on the rank of each of the plurality of members and generates the local meeting minutes F2 based on the plurality of local text records and the importance levels of the plurality of local text records.

After completing the local meeting minutes F2, the plurality of members can operate the mode switch 9 to switch the meeting minutes automatic generation system A from the mute mode to the non-mute mode. In the non-mute mode, the meeting minutes automatic generation system A can transmit the local meeting minutes F2 to the remote conference device E via the network interface 2.

Additionally, the control circuit 1 can also determine whether there is a correlation between the local meeting minutes F2 and the overall meeting minutes F1. For example, the control circuit 1 performs a search for a specific keyword that appears in the local meeting minutes F2 within the overall meeting minutes F1. When the number of times of the specific keyword appearing repeatedly in the overall meeting minutes F1 reaches a reference number, the control circuit 1 determines that there is a correlation between the local meeting minutes F2 and the overall meeting minutes F1. When there is a correlation between the local meeting minutes F2 and the overall meeting minutes F1, the control circuit 1 automatically integrates the local meeting minutes F2 into the overall meeting minutes F1.

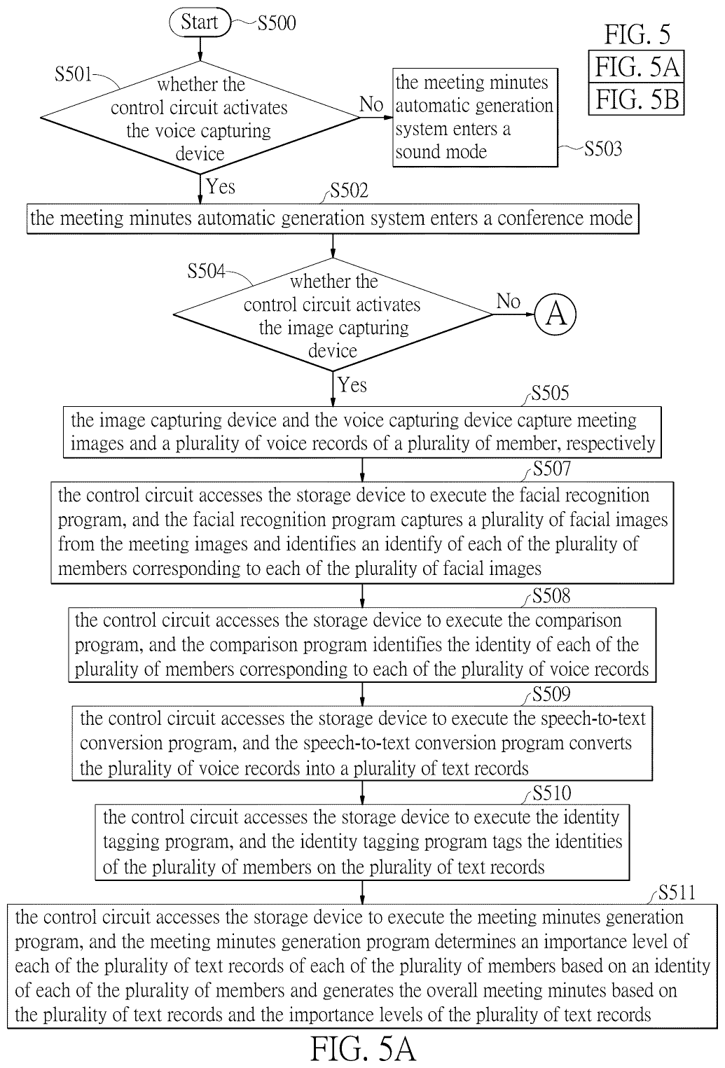

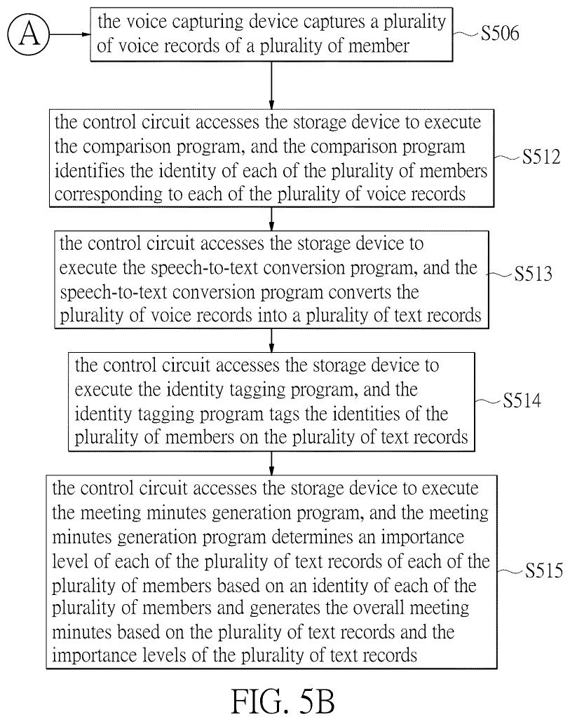

FIG. 5A and FIG. 5 B are flowcharts of the meeting minutes automatic generation method according to the first embodiment of the present disclosure. In S501, whether the control circuit 1 activates the voice capturing device 4.

If yes, in S502, the meeting minutes automatic generation system A enters a conference mode.

If no, in S503, the meeting minutes automatic generation system A enters a sound mode.

In S504, whether the control circuit 1 activates the image capturing device 7.

If yes, in S505, the image capturing device 7 and the voice capturing device 4 capture meeting images and a plurality of voice records of a plurality of member, respectively.

If no, in S506, the voice capturing device 4 captures a plurality of voice records of a plurality of member.

In S507, the control circuit 1 accesses the storage device 5 to execute the facial recognition program P5, and the facial recognition program P5 captures a plurality of facial images from the meeting images and identifies an identify of each of the plurality of members corresponding to each of the plurality of facial images.

For instance, the facial recognition training may be conducted using a Convolutional Neural Network (CNN) or a Faster Region-based Convolutional Neural Network. Alternatively, the facial recognition training may be conducted using the Stochastic Gradient Descent (SGD) algorithm.

In S508, the control circuit 1 accesses the storage device 5 to execute the comparison program P1, and the comparison program P1 identifies the identity of each of the plurality of members corresponding to each of the plurality of voice records.

For example, the comparison program P1 is a voiceprint comparison program, and identities of the plurality of members include names and ranks. The voiceprint comparison program may use one of several methods such as linear predictive cepstrum coefficient (LPCC), perceptual linear predictive (PLP), or Mel frequency cepstrum coefficient (MFCC) to extract voiceprint features from the sound, but the present disclosure is not limited thereto. Then, the voiceprint comparison program compares the extracted voiceprint features with the reference voiceprint features in the voiceprint database. When the extracted voiceprint features match one of the reference voiceprint features, the voiceprint comparison program identifies the name and rank of each of the plurality of members.

In S509, the control circuit 1 accesses the storage device 5 to execute the speech-to-text conversion program P2, and the speech-to-text conversion program P2 converts the plurality of voice records into a plurality of text records.

In S510, the control circuit 1 accesses the storage device 5 to execute the identity tagging program P3, and the identity tagging program P3 tags the identities of the plurality of members on the plurality of text records.

In S511, the control circuit 1 accesses the storage device 5 to execute the meeting minutes generation program P4, and the meeting minutes generation program P4 determines an importance level of each of the plurality of text records of each of the plurality of members based on an identity of each of the plurality of members and generates the overall meeting minutes F1 based on the plurality of text records and the importance levels of the plurality of text records.

The method in FIG. 5A and FIG. 5B further comprises S512 to S515, and S512 to S515 are the same as S508 to S511.

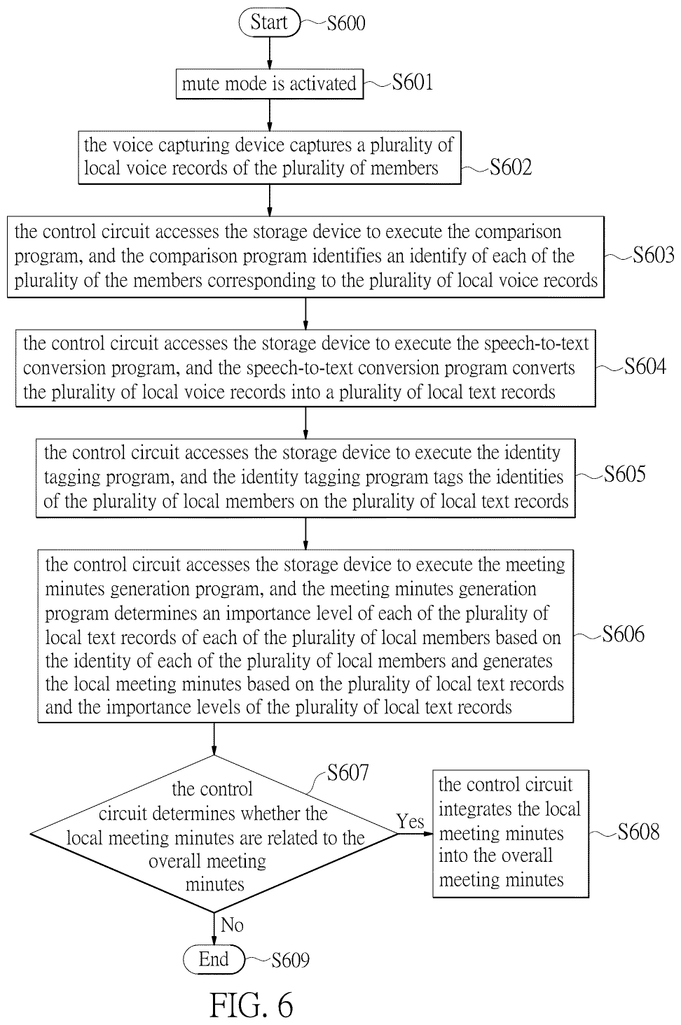

FIG. 6 is a flowchart of the meeting minutes automatic generation method according to the second embodiment of the present disclosure. In S601, a mute mode is activated.

In S602, the voice capturing device 4 captures a plurality of local voice records of the plurality of members.

In S603, the control circuit 1 accesses the storage device 5 to execute the comparison program P1, and the comparison program P1 identifies an identify of each of the plurality of the members corresponding to the plurality of local voice records. For example, the comparison program P1 is a voiceprint comparison program, and the identify of each of the plurality of the members may include the name and rank.

In S604, the control circuit 1 accesses the storage device 5 to execute the speech-to-text conversion program P2, and the speech-to-text conversion program P2 converts the plurality of local voice records into a plurality of local text records.

In S605, the control circuit 1 accesses the storage device 5 to execute the identity tagging program P3, and the identity tagging program P3 tags the identities of the plurality of local members on the plurality of local text records.

In S606, the control circuit 1 accesses the storage device 5 to execute the meeting minutes generation program P4, and the meeting minutes generation program P4 determines an importance level of each of the plurality of local text records of each of the plurality of local members based on the identity of each of the plurality of local members and generates the local meeting minutes F2 based on the plurality of local text records and the importance levels of the plurality of local text records.

In S607, the control circuit 1 determines whether the local meeting minutes F2 are related to the overall meeting minutes F1. If yes, the method proceeds to S608. The control circuit 1 integrates the local meeting minutes F2 into the overall meeting minutes F1. If no, the method in FIG. 6 ends.

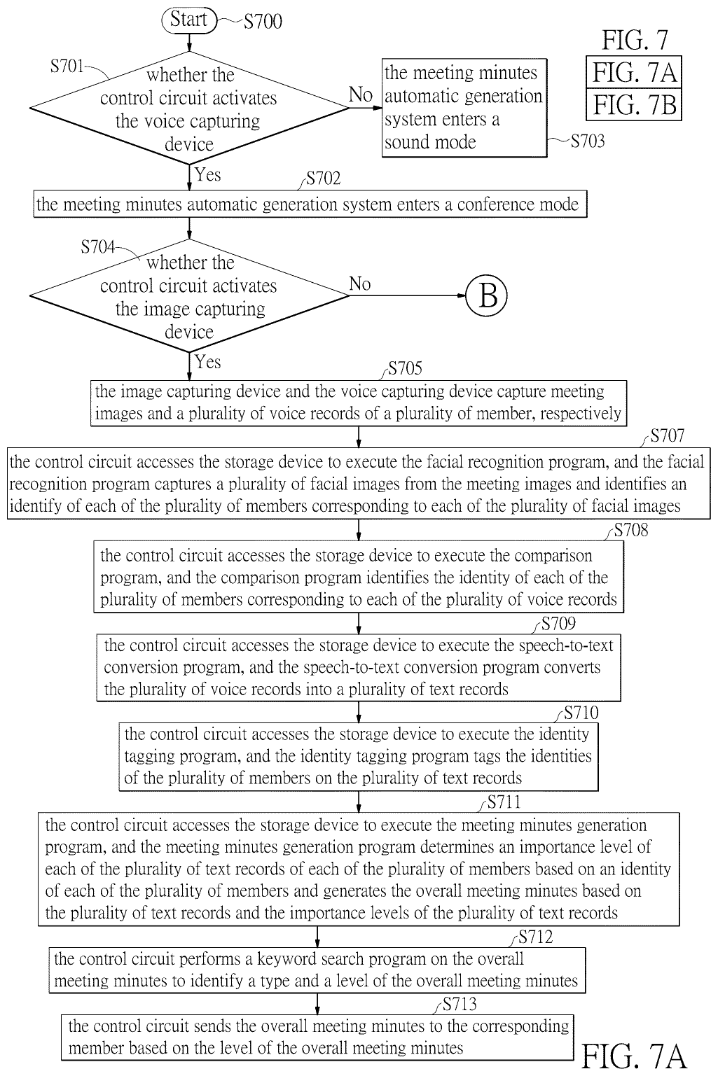

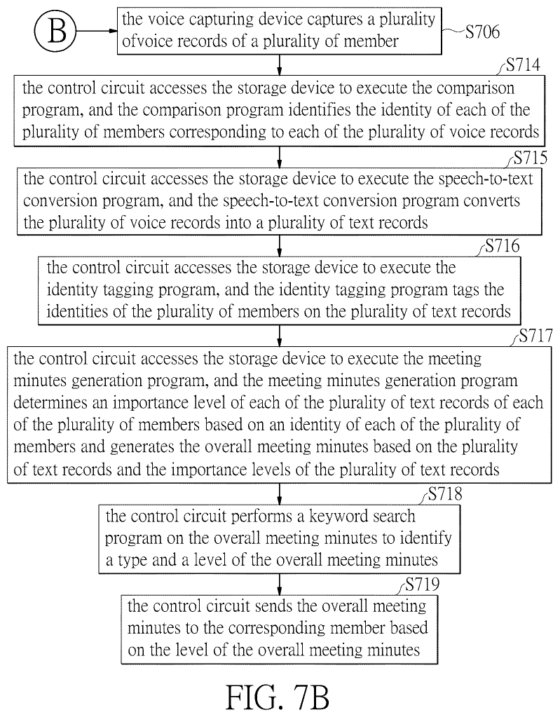

FIG. 7A and FIG. 7B are flowcharts of the meeting minutes automatic generation method according to the third embodiment of the present disclosure. Compared to FIG. 5A and FIG. 5B, the differences of the present embodiment are as follow.

In S712, the control circuit 1 performs a keyword search program on the overall meeting minutes F1 to identify a type and a level of the overall meeting minutes F1.

Levels can be classified based on confidentiality or importance of the project, among other criteria . . . , and the present disclosure is not limited thereto. For example, if the keyword related to novelty or advancement appears in the overall meeting minutes F1, it indicates that the meeting minutes F1 belongs to a highly confidential patent discussion. If the keyword such as customer lists, terms, or the confidentiality appears in the overall meeting minutes F1, it indicates that the meeting minutes F1 pertains to a highly confidential business contract meeting. If the keyword related to evaluations, absences, or years of service appears in the overall meeting minutes F1, it indicates that the meeting minutes F1 pertains to a moderately confidential personnel evaluation meeting. If the keyword such as travel locations or departure dates appears in the overall meeting minutes F1, it indicates that the meeting minutes F1 relates to a less confidential employee travel briefing.

In S713, the control circuit 1 sends the overall meeting minutes F1 to the corresponding member based on the level of the overall meeting minutes F1. For example, highly confidential meeting minutes are only sent to managers and above. Moderately and less confidential meeting minutes are only sent to directors and below. Since the meeting minutes are sent to members of corresponding ranks according to the confidentiality level, the effect of division of labor is achieved.

The method of FIG. 7A and FIG. 7B also includes S718 and S719, and S718 and S719 are the same as S712 and S713.

One of the beneficial effects of the present disclosure is that the meeting minutes automatic generation system and the meeting minutes automatic generation method provided by the present disclosure increase the accuracy of meeting minutes. This is because the overall meeting minutes are generated based on the identities of the members and the importance level of the spoken content, which serves as the basis for organizing meeting minutes.

Moreover, even in mute mode, the meeting minutes can still be generated and determined whether to be integrated into the overall meeting minutes. The meeting minutes can also be sent to the corresponding member based on the importance level of confidentiality.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A meeting minutes automatic generation system, comprising:
a control circuit;
a voice capturing device electrically connected to the control circuit and capturing a plurality of voice records of a plurality of members;
a storage device electrically connected to the control circuit;
wherein the control circuit accesses the storage device to execute a comparison program, a speech-to-text conversion program, and a meeting minutes generation program;
the comparison program identifies identities of the plurality of members corresponding to the plurality of voice records;
the speech-to-text conversion program converts the plurality of voice records into a plurality of text records;
the meeting minutes generation program determines an importance level of each of the plurality of text records based on an identity of each of the plurality of members; and
the meeting minutes generation program generates an overall meeting minutes based on the plurality of text records and importance levels of the plurality of text records.

2. The meeting minutes automatic generation system according to claim 1, wherein the storage device further stores an identity tagging program, the control circuit accesses the storage device to execute the identity tagging program, and the identity tagging program tags identities of the plurality of members on the plurality of text records.

3. The meeting minutes automatic generation system according to claim 1, further comprising an image capturing device electrically connected to the control circuit, wherein the storage device further stores a facial recognition program, the image capturing device captures a meeting image, and the control circuit accesses the storage device to execute the facial recognition program.

4. The meeting minutes automatic generation system according to claim 1, wherein when the meeting minutes automatic generation system is in a mute mode, the meeting minutes generation program generates a local meeting minutes based on a plurality of local text records in the mute mode, the control circuit determines whether the local meeting minutes are related to the overall meeting minutes, and integrates the local meeting minutes into the overall meeting minutes when the local meeting minutes are related to the overall meeting minutes.

5. A meeting minutes automatic generation method, comprising:
capturing a plurality of voice records of a plurality of members through a voice capturing device;
accessing a storage device through a control circuit to execute a comparison program, wherein the comparison program identifies an identity of each of the plurality of members corresponding to each of the plurality of voice records;
accessing the storage device through the control circuit to execute a speech-to-text conversion program, wherein the speech-to-text conversion program converts the plurality of voice records into a plurality of text records; and
accessing the storage device through the control circuit to execute a meeting minutes generation program, wherein the meeting minutes generation program determines an importance level of each of the plurality of text records based on an identify of each of the plurality of members and generates an overall meeting minutes based on the plurality of text records and importance levels of the plurality of text records.

6. The meeting minutes automatic generation method according to claim 5, further comprising: accessing the storage device through the control circuit to execute an identity tagging program, wherein the identity tagging program tags the identity of each of the plurality of members on the plurality of text records.

7. The meeting minutes automatic generation method according to claim 5, further comprising: capturing a meeting image through an image capturing device, and accessing the storage device through the control circuit to execute a facial recognition program.

8. The meeting minutes automatic generation method according to claim 5, further comprising: initiating a mute mode, wherein the meeting minutes generation program generates a local meeting minutes based on a plurality of local text records in the mute mode, the control circuit determines whether the local meeting minutes are related to the overall meeting minutes, and integrates the local meeting minutes into the overall meeting minutes when the local meeting minutes are related to the overall meeting minutes.

9. The meeting minutes automatic generation method according to claim 5, further comprising: accessing the storage device through the control circuit to execute a keyword comparison program, wherein the keyword comparison program identifies a type and a level of the overall meeting minutes.

10. The meeting minutes automatic generation method according to claim 9, further comprising: the control circuit determining whether the identities of the plurality of members correspond to the level, and wherein when the identities of the plurality of members correspond to the level, the control circuit sends the overall meeting minutes to the plurality of members.
